(19) United States
(12) Patent Application Publication
(10) Pub. No.: US 2009/0282990 A1
(43) Pub. Date: Nov. 19, 2009

(54) APPARATUS FOR CUTTING FOOD ITEMS

(76) Inventors: Ronald C. Farnum, Glen Ellyn, IL (US); Christopher T. Boyer, Oak Park, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/123,203

(22) Filed: May 19, 2008

(51) Int. Cl. A47J 17/00; B26B 3/04; B26D 3/26; B26D 1/00

(52) U.S. Cl. 99/537; 30/303; 30/114; 30/152

(57) ABSTRACT

An apparatus for cutting a food item includes a first portion defining an opening and a second portion having a blade. The second portion is at least partially received by the opening when in a storage position, and is at least partially received in the opening when in a cutting position that is inverted relative to the storage position.

### BACKGROUND

The present invention relates to apparatuses for cutting food items.

Cutting utensils, such as knives, are commonly used to cut or slice food items (e.g., fruits, vegetables, etc.). More specialized devices, such as apple wedgers, are also used to slice food items into multiple wedge-shaped pieces. However, when slicing food items with such wedgers, the food items are commonly placed on flat surfaces such that the food items may roll or shift when downward cutting forces are applied. Furthermore, convenient storage for the cutting device to inhibit scratching, dulling, or otherwise damaging the device or surrounding surfaces between uses is typically not provided.

### SUMMARY

In one embodiment, an apparatus for cutting a food item includes a first portion defining an opening and a second portion having a blade. The second portion is at least partially received by the opening when in a storage position, and is at least partially received in the opening when in a cutting position that is inverted relative to the storage position.

In another embodiment, the apparatus includes a base for supporting a food item. The base defines an opening. The apparatus also includes a cutting assembly having a handle and a blade supported by the handle. The cutting assembly is movable between a first position in which at least a portion of the handle fits within the opening to support the cutting assembly, and a second position in which the handle and the blade are inverted relative to the first position for cutting the food item supported on the base.

Other aspects of the invention will become apparent by consideration of the detailed description and accompanying drawings.

### BRIEF DESCRIPTION OF THE DRAWINGS

FIG. 1 is a perspective view of an embodiment of a cutting apparatus including a cutting assembly in a storage position.

FIG. 2 is a side view of the cutting apparatus of FIG. 1.

FIG. 3 is an exploded perspective view of the cutting apparatus.

FIG. 4 is a top plan view of a base of the cutting apparatus.

FIG. 5 is an exploded perspective of the cutting apparatus with the cutting assembly inverted relative to the base.

FIG. 6 is a perspective view of the cutting apparatus including the cutting assembly in an operative position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

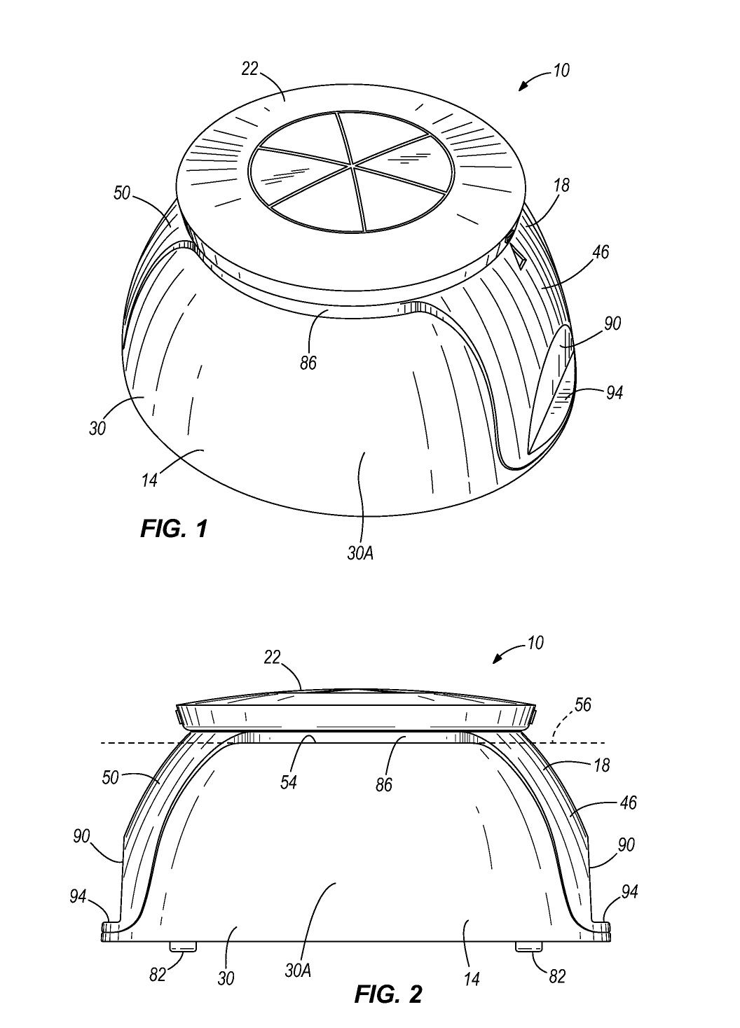

FIGS. 1-6 illustrate a cutting apparatus 10 according to an embodiment of the invention. The illustrated cutting apparatus 10 is a wedger operable to slice or wedge food items, such as, for example, fruits and vegetables, into multiple wedge-shaped pieces. In the illustrated embodiment, the cutting apparatus 10 can slice a food item into six wedge-shaped pieces or wedges, although in other embodiments the apparatus 10 could slice a food item into fewer or more wedges or into differently shaped pieces.

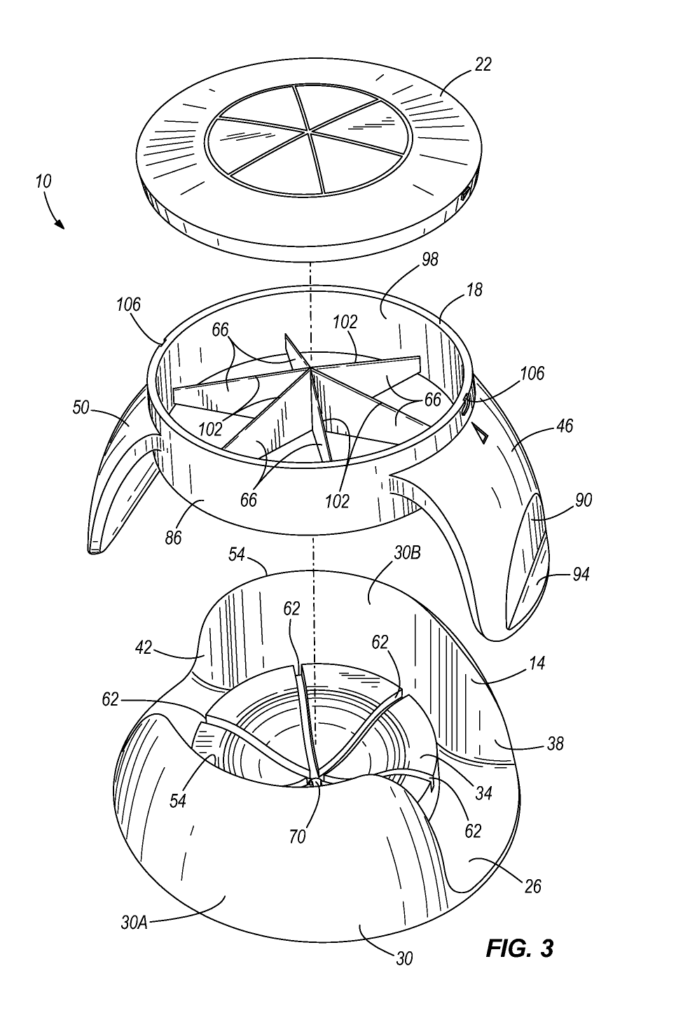

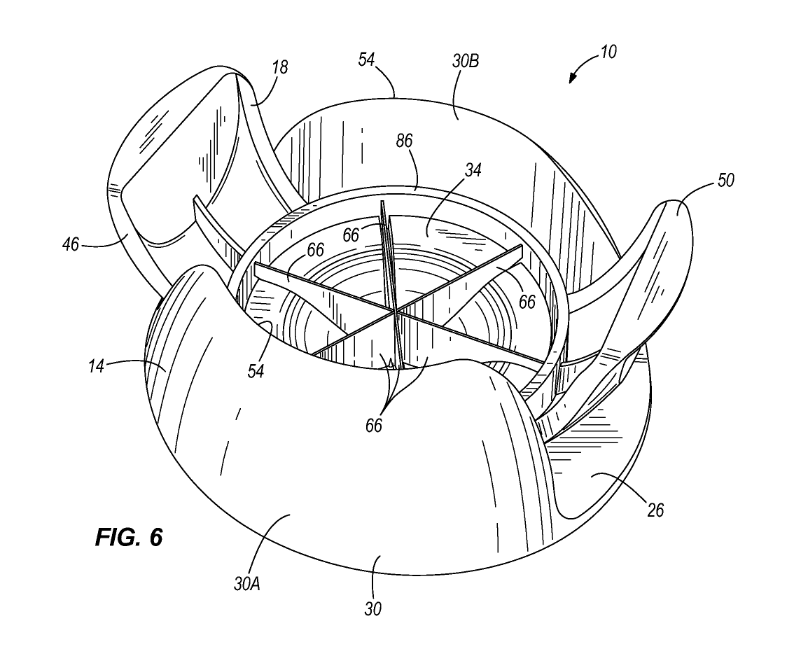

As shown in the figures, the cutting apparatus 10 includes a base 14 to support a food item, a cutting assembly 18 to slice the food item, and a cover 22 to cover the cutting assembly 18. The illustrated cutting assembly 18 is movable (e.g., invertible) relative to the base 14 between a collapsed, or storage, position (FIGS. 1 and 2) and an operative, or cutting, position (FIG. 6), as further discussed below. In the illustrated embodiment, the base 14, the cutting assembly 18, and the cover 22 may be composed of, for example, plastic, stainless steel, wood or the like to facilitate cleaning and/or disinfection of the cutting apparatus 10.

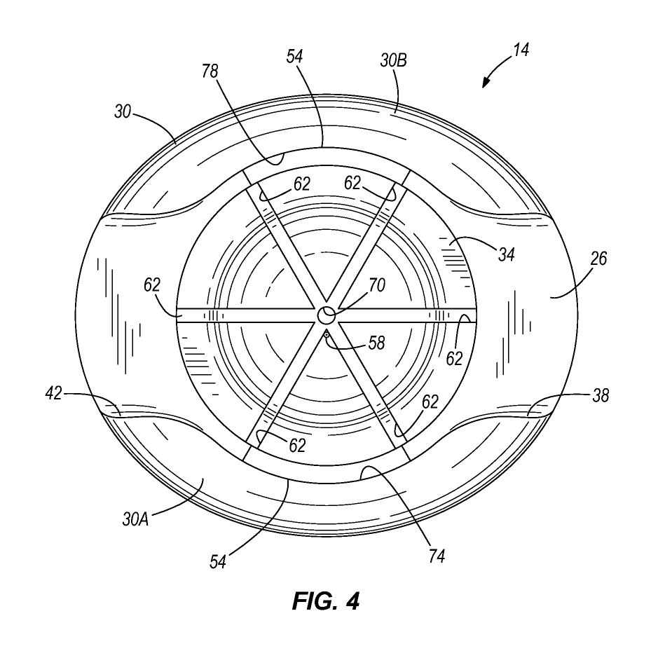

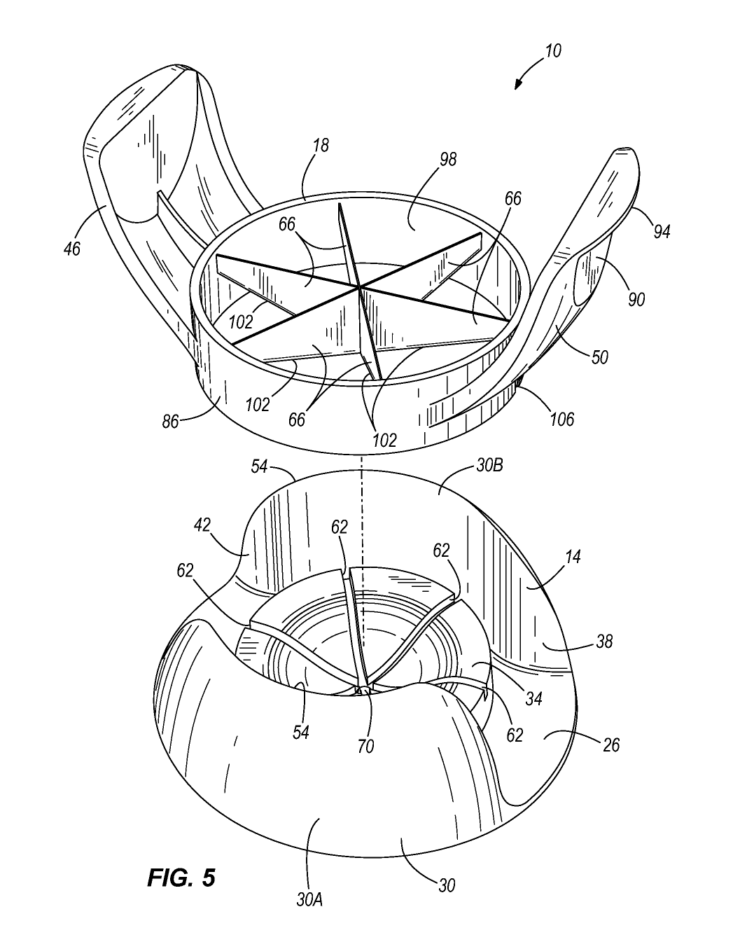

Referring to FIGS. 3 and 4, the base 14 includes a lower surface 26, a sidewall 30 extending upwardly from the lower surface 26, and a seat 34 supported on the lower surface 26. The sidewall 30 defines two openings 38, 42, or slots, that divide the sidewall 30 into a first sidewall portion 30A and a second sidewall portion 30B. The openings 38, 42 at least partially receive handles 46, 50 of the cutting assembly 18 when the cutting assembly 18 is in both the storage position and the operative position. An upper end 54 (e.g., an upper edge) of the sidewall 30 defines an upper perimeter of the base 14 and a generally horizontally extending plane 56 (FIG. 2). In the illustrated embodiment, the sidewall 30 is curved such that the upper perimeter is disposed radially inward of a lower perimeter defined by the lower surface 26 of the base 14. As shown in FIG. 2, the plane 56 extends through a portion of the cutting assembly 18 when the cutting assembly 18 is received by the base 14 in the storage position.

The seat 34 is positioned radially inward of the sidewall 30 and is configured to support a food item. As shown in FIG. 3, the seat 34 is concave, or cup-shaped, to match the general contour of spherical food items (e.g., apples, tomatoes, potatoes, radishes, etc.). The seat 34 includes a barb 58 (FIG. 4), or spike, extending upwardly from the seat 34 to engage a food item. When the food item is pushed onto the seat 34 (e.g., by an operator before cutting or with the cutting assembly 18 during cutting), the barb 58 engages (e.g., pierces) the food item to reduce movement of the food item relative to the base 14.

The illustrated seat 34 defines three intersecting slots 62 corresponding to three intersecting blades 66 of the cutting assembly 18. In other embodiments, the seat 34 may define fewer, more, or differently arranged slots 66 corresponding to a cutting assembly including fewer, more, or differently arranged blades. The illustrated slots 62 converge at a centrally located drain 70 in the seat 34. The drain 70 helps fluid drain from the base 14, and more particularly from the cup-shaped seat 34, when the cutting assembly 18 slices a food item. In the illustrated embodiment, the base 14 also defines two side drains 74, 78 in the form of elongated slots extending through the lower surface 26 also to help fluid drain from the base 14. As shown in FIG. 4, the first side drain 74 is positioned between the seat 34 and the first sidewall portion 30A, and the second drain 78 is positioned between the seat 34 and the second sidewall portion 30B. In other embodiments, the side drains 74, 78 may be positioned elsewhere on the base 14 and/or the base 14 may include fewer or more drains.

Referring to FIG. 2, the base 14 also includes four feet 82 (only two of which are shown) disposed beneath the lower surface 26 of the base 14. The illustrated feet 82 are composed of, for example, an elastomeric material that resists shifting of the base 14 along a support surface (e.g., a countertop, a table, a shelf, etc.), thereby reducing the possibility of scratching or otherwise damaging the support surface. The feet 82 also deflect to help absorb impacts that may be created during operation of the cutting apparatus 10.

As shown in FIGS. 3 and 5, the cutting assembly 18 includes first and second handles 46, 50, a ring 86, and the blades 66. The handles 46, 50 are coupled to the ring 86 and extend axially and radially outwardly from the ring 86. In the illustrated embodiment, the handles 46, 50 are formed as a single piece with the ring 86. In other embodiments, the handles 46, 50 may be separate pieces that are removably or permanently attached to ring 86 via fasteners (e.g., threaded fasteners, adhesives, or the like). Each handle 46, 50 includes a flattened surface portion 90 and a lip 94 to facilitate handling or grasping of the cutting assembly 18 when in use. In some embodiments, a portion of each handle 46, 50 may be covered or coated with an elastomeric member or material to further facilitate gripping of the cutting assembly 18 during operation.

As shown in FIGS. 1 and 2, the handles 46, 50 are received substantially within the openings 38, 42 in the sidewall 30 when the cutting apparatus 10 is in the storage position. The illustrated handles 46, 50 are curved to extend away from the ring 86 and to correspond generally to the curvature of the sidewall 30. The handles 46, 50 thereby help define a portion of the sidewall 30 when the cutting assembly 18 is received by the base 14 in the storage position. In the illustrated embodiment, the handles 46, 50 slightly protrude beyond an outer surface of the sidewall 30 to facilitate removal of the cutting assembly 18 from the base 14. In other embodiments, the handles 46, 50 may be generally straight to conform to a generally straight sidewall and/or the handles 46, 50 may be substantially flush with the sidewall 30 when the cutting assembly 18 is received by the base 14.

The ring 86 defines a generally circular aperture 98 and supports the blades 66. In some embodiments, the ring 86 and/or the aperture 98 may be, for example, rectangular, hexagonal, oblong, or the like. The illustrated ring 86 fits at least partially within the sidewall 30 when the cutting assembly is in the storage position (FIGS. 1 and 2) and the inverted operative position (FIG. 6). As shown in FIG. 2, when the cutting assembly 18 is in the storage position, the plane 56 defined by the upper surface 54 of the sidewall 30 extends through the ring 86, and thereby the blades 66. Accordingly, a portion of the ring 86 extends upwardly past the sidewall 30 when the cutting assembly 18 is received by the base 14. As shown in FIG. 6, when the cutting assembly 18 is in the operative position, the ring 86 is adjacent to the lower surface 26 of the base 14 and fits substantially between the sidewall 30 and the seat 34. In addition, in the inverted operative position the ring 86 is positioned substantially beneath the plane 56, while the handles 46, 50 extend upwardly past the upper surface 54 of the sidewall 30 such that the lips 94 are substantially above the plane 56.

Referring to FIGS. 3 and 5, the cutting assembly 18 includes three blades 66 that extend across the aperture 98 and intersect one another such that the blades 66 are operable to slice a food item into six wedges. In other embodiments, the cutting assembly 18 may include fewer, more, or differently configured blades to slice a food item into fewer or more wedges or differently shaped pieces. Each blade 66 includes a cutting edge 102 and is tapered such that the blades 66 are tallest near a center of the aperture 98 and shortest adjacent to the ring 86. When the cutting assembly 18 is in the storage position, the cutting edges 102 face away from the base 14, as shown in FIG. 3. When the cutting assembly 18 is in the operative position, the cutting assembly 18 is inverted relative to the base 14 such that the cutting edges 102 face toward the base 14, as shown in FIG. 5. In the illustrated embodiment, the ends of the blades 66 are molded into the ring 86 and each blade 66 defines one or more slots (not shown) that receive the other blades 66 where the blades 66 intersect. In other embodiments, the blades 66 may be coupled to the ring 86 and to one another using other suitable coupling means (e.g., welding, fasteners, adhesives, brazing, etc.). For example, the cutting assembly may include blades 66 having first ends coupled to the ring 86 and second ends that meet and are coupled to one another substantially in the center of the ring 86. In further embodiments, the cutting assembly 18 may include a central ring blade that also cores the food item, in which case the blades 66 may extend radially away from the central ring blade and have first ends coupled to the ring 86 and opposite ends coupled to the central ring blade.

As shown in FIGS. 2 and 3, the cover 22 is removably coupled to the ring 86 of the cutting assembly 18 to cover the cutting edges 102 of the blades 66 when the cutting assembly 18 is in the storage position. The cover 22 includes a locking mechanism to secure the cover 22 to the cutting assembly 18. In the illustrated embodiment, the locking mechanism includes two inwardly extending projections (not shown) that engage the ring 86. Referring to FIG. 3, the ring 86 includes two L-shaped slots 106 configured to receive the projections. The projections fit within and slide relative to the slots 106 to secure the cover 22 to the ring 86. In the illustrated embodiment, the cover 22 is slightly rotated relative to the cutting assembly 18 in one direction (e.g., clockwise) to lock the cover 22 to the cutting assembly 18, and is slightly rotated relative to the cutting assembly 18 in an opposite direction (e.g., counterclockwise) to unlock the cover 22 from the cutting assembly 18 such that the cover 22 may be removed.

Starting in the storage position shown in FIGS. 1 and 2, the handles 46, 50 of the cutting assembly 18 are received by the openings 38, 42 in the sidewall 30 of the base 14 such that the handles 46, 50 substantially define a portion of the sidewall 30. The cover 22 is securely attached to the cutting assembly 18, covering the cutting edges 102 of the blades 66. Accordingly, the cutting apparatus 10 has a compact configuration that is suitable for storage. Furthermore, the blades 66 are enclosed within the base so that they will not scratch any surrounding surfaces or cut a person handling the cutting apparatus.

In operation, the cover 22 is rotated relative to the cutting assembly 18 to unlock the projections of the cover 22 from the L-shaped slots 106 in the ring 86, and the cover 22 is removed from the cutting assembly 18. The cutting assembly 18 is also removed from the base 14, as shown in FIG. 3. Then, as shown in FIG. 5, the cutting assembly 18 is inverted relative to the base 14 such that the cutting edges 102 of the blades 66 face the base 14. A food item (e.g., an apple, a tomato, a potato, a radish, etc.) is positioned on the seat 34 of the base 14. The food item may be pressed downwardly toward the base 14 until the barb 58 engages and/or pierces the food item.

When the food item is properly positioned on the base 14, the inverted cutting assembly 18 is moved toward the base 14 until the blades 66 contact the food item. The handles 46, 50 are generally radially aligned with the openings 38, 42, and the cutting assembly 18 is then forcibly pushed toward the base 14, thereby slicing the food item into six wedge-shaped pieces. As the cutting assembly 18 slices the food item, the handles 46, 50 are partially received by and move downwardly in the openings 38, 42 in the sidewall 30. The cutting assembly 18 continues to cut through the food item until the blades 66 are received in the slots 62 in the seat 34 and the ring 86 contacts the lower surface 26 of the base 14, as shown in FIG. 6. The wedge-shaped pieces of the food item may then be removed from the cutting apparatus 10 and the cutting assembly 18 may be removed from the base 14. Another food item may then be positioned on the seat 34, or the cutting assembly 18 may be re-inverted and received by the base 14 (i.e., in the storage position) such that the cutting apparatus 10 is returned to the compact configuration for storage.

What is claimed is:

1. An apparatus for cutting a food item, the apparatus comprising:
a first portion defining an opening;
a second portion including a blade, the second portion at least partially received by the opening when in a storage position, and at least partially received in the opening when in a cutting position that is inverted relative to the storage position.

2. The apparatus of claim 1, wherein the second portion includes a handle, and wherein the handle is at least partially received in the opening when the second portion is in the storage and cutting positions.

3. The apparatus of claim 2, wherein the first portion defines a second opening and the second portion includes a second handle, and wherein the second handle is at least partially received in the second opening when the second portion is in the storage and cutting positions.

4. The apparatus of claim 1, wherein the first portion includes a sidewall, and wherein the sidewall defines the opening.

5. The apparatus of claim 1, wherein the sidewall includes an upper end defining a plane, and wherein the plane extends through at least a portion of the blade when the second portion is in the storage position.

6. The apparatus of claim 1, wherein the blade is spaced apart from the first portion when the second portion is in the storage position and is adjacent to the first portion when the second portion is in the cutting position.

7. The apparatus of claim 1, wherein the second portion includes a ring defining an aperture, and wherein the blade extends at least partially across the aperture.

8. The apparatus of claim 1, further comprising a third portion removably coupled to the second portion, wherein the third portion covers at least a portion of the blade when the second portion is in the storage position.

9. The apparatus of claim 1, wherein the blade includes a cutting edge, and wherein the cutting edge faces away from the first portion when the second portion is in the storage position and faces toward the first portion when the second portion is in the cutting position.

10. An apparatus for cutting a food item, the apparatus comprising:
a base for supporting the food item, the base defining an opening; and
a cutting assembly including a handle and a blade supported by the handle, the cutting assembly movable between a first position in which at least a portion of the handle fits within the opening to support the cutting assembly, and a second position in which the handle and the blade are inverted relative to the first position for cutting the food item supported on the base.

11. The apparatus of claim 10, wherein the base defines a second opening and the cutting assembly includes a second handle supporting the blade, and wherein the second handle fits within the second opening when the cutting assembly is in the first position.

12. The apparatus of claim 10, wherein the base includes a sidewall having an upper end that defines a plane, and wherein the plane extends through at least a portion of the blade when the cutting assembly is in the first position.

13. The apparatus of claim 10, wherein the blade includes a cutting edge, and wherein the cutting edge faces away from the base when the cutting assembly is in the first position and faces toward the base when the cutting assembly is in the second position.

14. The apparatus of claim 10, wherein the blade is spaced apart from the base when the cutting assembly is in the first position, and wherein the blade is adjacent to the base when the cutting assembly is in the second position.

15. The apparatus of claim 10, wherein the cutting assembly includes a ring coupled to the handle and defining an aperture, and wherein the blade extends at least partially across the aperture.

16. The apparatus of claim 15, wherein the base includes a sidewall defining the opening, and wherein the ring fits within a perimeter defined by the sidewall when the cutting assembly is in the first and second positions.

17. The apparatus of claim 10, wherein the cutting assembly includes a plurality of blades supported by the handle.

18. The apparatus of claim 10, further comprising a cover removably coupled to the cutting assembly, wherein the cover covers at least a portion of the blade when the cutting assembly is in the first position.

19. The apparatus of claim 10, wherein the base includes a seat configured to support a food item.

20. The apparatus of claim 19, wherein the seat includes a groove, and wherein the groove receives a portion of the blade when the cutting assembly is in the second position.

21. The apparatus of claim 10, wherein the base includes a barb configured to engage the food item supported on the base to reduce movement of the food item relative to the base.
